(19) United States
(12) Patent Application Publication
(10) Pub. No.: US 2026/0236000 A1
(43) Pub. Date: Aug. 13, 2026

(54) NONLINEAR PHYSICAL COMPUTING ARCHITECTURE WITH DYNAMIC INTRA-SUBSTRATE DOMAIN SEGMENTATION AND CONTROLLED DOMAIN EVOLUTION

(71) Applicant: Anil P Rami, MOUNDSVILLE, WV (US)

(72) Inventor: Anil P Rami, MOUNDSVILLE, WV (US)

(21) Appl. No.: 19/640,336

(22) Filed: Apr. 6, 2026

Related U.S. Application Data
(63) Continuation of application No. 19/549,231, filed on Feb. 25, 2026.

(51) Int. Cl. G05B 15/02; G06F 17/13

(52) U.S. Cl. CPC G05B 15/02; G06F 17/13

(57) ABSTRACT

A nonlinear physical computing system comprising a continuous physical substrate supporting dynamically formable computational domains defined by spatial differentiation of at least one governing parameter field. Domains may be predefined, dynamically induced, or modified during operation without lithographic patterning. Field-induced domain segmentation is achievable through controlled reversal of spontaneous polarization via applied electric field. Each domain exhibits persistent modification of governing parameter fields resulting in history-dependent convergence behavior, independently verifiable through reset-controlled baseline comparison. Dynamically formed domains exhibit distinct attractor basin topology from surrounding substrate regions. Independent domain controllability enables differential persistence magnitude, quantifiable through convergence time, trajectory length, or energy dissipation metrics. The system supports staggered domain operation for continuous computational availability and excludes discrete memory cells, programmable weight matrices, and stored routing topology.

### CROSS-REFERENCE TO RELATED APPLICATIONS

This application is a continuation of U.S. patent application Ser. No. 19/549,231, titled “NONLINEAR PHYSICAL COMPUTING ARCHITECTURE WITH DOMAIN-WIDE PARAMETER-FIELD RESHAPING, ATTRACTOR-LANDSCAPE MODIFICATION, GRADIENT PERSISTENCE MODULATION, AND MULTI-DOMAIN ORCHESTRATION,” the entirety of which is incorporated herein by reference. This application is further related to U.S. patent application Ser. No. 19/452,222, Ser. No. 19/455,843, and Ser. No. 19/547,362, the entireties of which are incorporated herein by reference.

### FIELD OF THE INVENTION

The present invention relates to nonlinear physical computing systems implemented in continuous media, and more specifically to architectures enabling dynamic formation, differentiation, and control of computational domains within a single continuous substrate.

### BACKGROUND OF THE INVENTION

Conventional computing systems rely on discrete memory elements and predefined routing structures. Existing multi-domain and neuromorphic systems employ fixed or pre-fabricated structures and do not support dynamic formation of computational domains during operation.

Prior systems do not provide domain segmentation achieved through controlled reversal of spontaneous polarization in a ferroelectric medium, enabling reconfigurable domain boundaries without lithographic patterning.

Prior systems do not provide reset-verified convergence behavior at the individual domain level, wherein modification of convergence kinetics within a domain is verified by demonstrating restoration of baseline convergence metrics following domain reset.

Prior systems do not provide domain-level attractor basin topology modification, wherein dynamically formed domains exhibit distinct attractor basin topology from surrounding substrate regions as a consequence of localized parameter field reshaping.

Prior ferroelectric systems employing dynamic domain formation have used domain state for data storage, signal switching, or modulation. Such systems do not treat ferroelectric domains as computational regions whose persistent polarization state alters convergence dynamics of nonlinear physical evolution, do not orchestrate domains based on persistence depth and convergence metrics, and do not verify domain-level convergence behavior through reset-controlled baseline comparison.

There remains a need for systems in which computational structure itself may be formed and modified dynamically in response to system state, with reset-verified convergence behavior and reconfigurable domain boundaries achievable without fabrication processes.

### SUMMARY OF THE INVENTION

The invention provides a nonlinear physical computing architecture comprising a continuous substrate supporting dynamically formable computational domains. Domains may be spatially predefined or induced during operation through controlled excitation. Each domain exhibits persistent modification of governing parameter fields resulting in measurable changes in convergence behavior. Independent control and orchestration of domains enable adaptive computation based on system state.

In certain embodiments, convergence behavior modification within each domain is verified through reset-controlled baseline comparison, wherein reset of domain parameter field and reapplication of substantially identical excitation restores baseline convergence metrics, confirming that modified convergence behavior arises from persistent parameter field reshaping rather than irreversible material change.

In certain embodiments, dynamically formed domains exhibit distinct attractor basin topology from surrounding substrate regions, wherein the location of fixed points, stability eigenvalue spectra, basin boundary geometry, and bifurcation thresholds within a domain differ from adjacent non-domain regions as a consequence of localized parameter field reshaping.

### DETAILED DESCRIPTION

### Domain Segmentation and Formation

Domains within the substrate may be defined by material composition, field-induced modification, structural variation, phase variation, or combinations thereof. Segmentation may be static or dynamically induced and does not require lithographic patterning.

In certain embodiments, material-based domain segmentation is achieved through spatially controlled doping or compositional variation within the substrate. Different dopant profiles produce different persistence timescales, response sensitivities, and reset thresholds within spatially distinct regions, enabling a single substrate to simultaneously support domains optimized for different computational functions.

In certain embodiments, domains are implemented as physically separate substrates coordinated through a supervisory control architecture. Each substrate may be independently optimized through material selection, doping profile, geometry, and operating conditions.

### Dynamic Domain Evolution

Domains may be created, expanded, contracted, merged, split, or erased during operation through controlled excitation or intrinsic system dynamics. Domain boundaries may be reconfigurable or emergent from parameter field evolution.

Dynamic domain formation during operation enables the computing system to adapt its computational structure in response to operational demands without physical modification of the substrate. Domain merging occurs when persistent parameter field distributions of adjacent domains overlap sufficiently to produce coupled nonlinear evolution. Domain splitting occurs when excitation patterns induce localized parameter field reshaping that creates an interior region with distinct convergence behavior from the surrounding domain.

### Persistence and Convergence

Persistent reshaping of governing parameter fields produces history-dependent convergence behavior. Modified convergence may be verified by resetting the parameter field and reapplying excitation to compare baseline convergence metrics.

Persistence magnitude within each domain may be defined as the magnitude of deviation of the governing parameter field from baseline distribution and may vary continuously between baseline and fully accumulated reshaped states. Persistence magnitude is quantifiable through convergence time, state-space trajectory length defined as the integral of the norm of dX/dt over the convergence interval, energy dissipation per convergence event, or spectral analysis of state variable evolution.

Reset mechanisms applicable to individual domains include controlled thermal relaxation, sub-threshold excitation, reverse-bias electrical pulses, reversal of ferroelectric polarization within a domain region, and magnetic realignment directed at the domain region.

### Attractor Topology

Dynamically formed domains may exhibit distinct attractor basin topology relative to surrounding regions, enabling differentiated convergence pathways within a single substrate. Attractor basin topology modification comprises alteration of at least one of fixed point location, stability eigenvalue spectra, basin boundary geometry, or bifurcation thresholds within the domain. State-space trajectory length within a domain may be measurably reduced relative to baseline measured following domain reset.

### Exemplary Embodiment

In one embodiment, a ferroelectric substrate is used wherein domain segmentation is achieved through controlled reversal of spontaneous polarization via applied electric fields. Domains are dynamically formed and reshaped through field control, enabling persistent and reconfigurable computational regions without lithographic patterning. Field-induced domain boundaries are reconfigurable through reapplication of electric field stimuli of appropriate magnitude and spatial distribution. Partial polarization reversal may produce graded domain boundaries with continuously varying parameter field distributions.

In another embodiment, domain segmentation is achieved through spatially controlled material variation within a single continuous substrate, wherein distinct dopant profiles create regions with differing persistence timescales and convergence characteristics.

In another embodiment, domains comprise physically separate substrates coordinated through supervisory control circuitry, wherein each substrate is independently optimized for a distinct computational function within the multi-domain architecture.

### Orchestration

A control system coordinates domain excitation, persistence modulation, and reset operations. Orchestration may be centralized or distributed and may utilize feedback from convergence metrics. Supervisory control circuitry may schedule domain reset operations based on measured convergence metrics, minimizing at least one of thermal accumulation, material fatigue, nonlinear instability, or undesirable attractor transitions.

In certain embodiments, at least one domain operates in an accumulated persistence state while at least one other domain undergoes reset, enabling continuous computational availability without global substrate reset.

### Structural Exclusions

The disclosed architecture does not rely upon independently addressable discrete memory cells, programmable weight matrices, stored routing topology, matrix multiply-accumulate computation structures, or lithographic patterning for domain definition.

1. A nonlinear physical computing system comprising a continuous physical substrate and a plurality of computational domains defined by spatial differentiation of at least one governing parameter field, wherein at least a subset of said computational domains are dynamically formable during operation, and wherein said spatial differentiation produces persistent modification of said at least one governing parameter field resulting in altered convergence behavior quantifiably measurable relative to a baseline established following reset of said at least one governing parameter field.

2. The system of claim 1, wherein domains are dynamically formed via controlled excitation.

3. The system of claim 1, wherein domains are independently controllable with respect to excitation or persistence modulation.

4. The system of claim 1, wherein domain boundaries are reconfigurable.

5. The system of claim 1, wherein persistence magnitude within at least one domain exceeds a threshold value sufficient to produce a measurably reduced convergence time relative to baseline.

6. The system of claim 5, wherein said modified convergence behavior is verified by resetting said at least one governing parameter field and reapplying excitation to measure baseline convergence, thereby confirming that convergence behavior modification arises from persistent parameter field reshaping rather than irreversible material change or global thermal variation.

7. The system of claim 1, wherein segmentation is achieved by material, field-induced, structural, or phase differentiation.

8. The system of claim 7, wherein field-induced segmentation is achieved through controlled reversal of spontaneous polarization via applied electric field.

9. The system of claim 1, wherein domains are formed without lithographic patterning.

10. The system of claim 1, wherein domain behavior is dependent on prior system state.

11. The system of claim 1, wherein domains exhibit distinct attractor basin topology relative to surrounding substrate regions, wherein attractor basin topology modification comprises alteration of at least one of fixed point location, stability eigenvalue spectra, basin boundary geometry, or bifurcation thresholds.

12. The system of claim 3, wherein persistence magnitude is quantifiable via convergence time, trajectory length, or energy dissipation.

13. The system of claim 1, further comprising control circuitry configured to orchestrate domain interaction.

14. The system of claim 1, wherein multiple domains operate concurrently with differing persistence states.

15. The system of claim 1, wherein at least two domains exhibit measurably different convergence times under substantially identical excitation conditions.

16. The system of claim 12, wherein state-space trajectory length L is defined as the integral of the norm of dX/dt over the convergence interval, and wherein trajectory length within at least one domain is measurably reduced relative to baseline measured following domain reset.

17. The system of claim 8, wherein said field-induced domain boundaries are reconfigurable through reapplication of electric field stimuli of appropriate magnitude and spatial distribution.

18. The system of claim 8, wherein partial polarization reversal produces graded domain boundaries with continuously varying parameter field distributions.

19. The system of claim 7, wherein material-based segmentation is achieved through spatially controlled doping profiles producing distinct persistence timescales within spatially separated regions of a single continuous substrate.

20. The system of claim 1, wherein at least one domain comprises a physically separate substrate coordinated through supervisory control circuitry.

21. The system of claim 13, wherein said control circuitry schedules domain reset operations based on measured convergence metrics, wherein scheduling minimizes at least one of thermal accumulation, material fatigue, nonlinear instability, or undesirable attractor transitions.

22. The system of claim 1, wherein at least one domain operates in an accumulated persistence state while at least one other domain undergoes reset, enabling continuous computational availability without global substrate reset.

23. The system of claim 6, wherein said domain reset is achieved through at least one of controlled thermal relaxation, sub-threshold excitation, reverse-bias electrical pulses, reversal of ferroelectric polarization within said at least one domain, or magnetic realignment directed at said at least one domain.

24. The system of claim 1, wherein the system lacks independently addressable discrete memory cells, programmable weight matrices, stored routing topology, and matrix multiply-accumulate computation structures.

25. A method of physical computation comprising: providing a continuous physical substrate; inducing at least one computational domain through controlled excitation producing persistent reshaping of at least one governing parameter field; measuring baseline convergence metrics within said at least one computational domain; allowing persistent reshaping to accumulate through repeated excitation; measuring modified convergence metrics demonstrating acceleration relative to baseline; operating a reset mechanism to substantially remove reshaping within said at least one computational domain; and verifying restoration of baseline convergence metrics under substantially identical excitation conditions.

26. The method of claim 25, wherein inducing at least one computational domain comprises applying electric field stimuli sufficient to reverse spontaneous polarization within a defined region of a ferroelectric substrate.
